(19) United States
(12) Patent Application Publication
(10) Pub. No.: US 2025/0172848 A1
(43) Pub. Date: May 29, 2025

(54) OPTICAL DEVICE, TRANSMITTER, AND TRANSCEIVER

(71) Applicant: FUJITSU OPTICAL COMPONENTS LIMITED, Kawasaki-shi (JP)

(72) Inventor: Tamotsu AKASHI, Atsugi (JP)

(73) Assignee: FUJITSU OPTICAL COMPONENTS LIMITED, Kawasaki-shi (JP)

(21) Appl. No.: 18/924,570

(22) Filed: Oct. 23, 2024

(30) Foreign Application Priority Data
Nov. 28, 2023 (JP) 2023-201158

(51) Int. Cl. G02F 1/225; G02F 1/21; H04B 10/40

(52) U.S. Cl. CPC G02F 1/225; G02F 1/212; H04B 10/40

(57) ABSTRACT

An optical device includes: a substrate having a first surface and a second surface opposite to each other; an optical modulating unit provided in the substrate, at the first surface, the optical modulating unit having a plurality of electrodes for modulating an optical signal; a plurality of vias extending in a thickness direction of the substrate and connected to a plurality of ground electrodes included in the plurality of electrodes; and a second-surface electrode provided at the second surface of the substrate and connected to the plurality of vias.

### CROSS REFERENCE TO RELATED APPLICATIONS

This application is based upon and claims the benefit of priority of the prior Japanese Patent Application No. 2023-201158, filed on Nov. 28, 2023, the entire contents of which are incorporated herein by reference.

### FIELD OF THE INVENTION

Embodiments discussed herein related to an optical device, a transmitter, and a transceiver.

### BACKGROUND OF THE INVENTION

In order to cope with the rapid increase in optical transmission capacity of IP data in recent years, there is an urgent need to develop communication devices and equipment to support this. For example, optical modulators for high-speed data transmission in a 400 Gbit/sec class (multiple-level modulation, for example, 16QAM modulation method, with a symbol rate of 64 Gbaud) are beginning to be put into practical use. Further, standardization has begun for an 800 Gbit/sec-class (symbol rate of 128 Gbaud), requiring optical modulators with even wider bandwidth. On the other hand, to expand the transmission capacity in data centers and the like, more optical transmission equipment and optical transceivers have to be installed and thus, there is also a demand for smaller optical devices.

Silicon modulators are optical modulators capable of high-speed operation of a 400 Gbit/sec class (64 Gbaud class symbol rate) and enable size reductions. These silicon modulators have a limit in terms of modulation speed and while the silicon modulators may handle speeds up to about 64 Gbaud, application thereof to high-speed transmissions exceeding this is known to be difficult. Thus, active development of modulator materials other than silicon is underway. On the other hand, silicon photonics-based optical devices have an advantage of being compact and capable of being integrated on a silicon substrate. Thus, methods are being considered for integrating modulator materials other than silicon on a silicon substrate, such as integrating a material such as an EO polymer that is capable of high-speed modulation operation and has a high electro-optic constant (called a high EO coefficient) for a modulator portion in a silicon photonics integrated circuit.

As prior art in which a photoelectric conversion function is provided on a silicon substrate, the following patent documents have been disclosed. For example, a through-chip via is provided as a gate electrode in a semiconductor substrate having a photoelectric conversion device; a source region and a drain lane region are provided around the through-electrode; and an electrode of the photoelectric conversion device is connected to the gate electrode of the through-electrode. Further, there is a technology related to integrated silicon photonics devices in broadband communications, in which multiple through-chip vias are provided in a substrate of a photoelectric module based on silicon photonics. Further, there is a technology related to photonic integrated circuits, in which multiple optical ICs are provided on an insulator wafer and are connected through substrate vias. Further, there is a high-speed spatial light modulator having a substrate and a stacked body, the substrate having a through hole connecting the front and back of the substrate. Further, there are circuit boards and electronic devices that include photoelectric modules having circuit patterns and through-chip vias in a semiconductor substrate such as a silicon wafer. For examples, refer to International Publication No. WO 2017/138197, U.S. Patent Application Publication No. 2020/0152574, U.S. Patent Application Publication No. 2021/0302654, International Publication No. WO 2021/132374, and Japanese Laid-Open Patent Publication No. 2009-277927.

Further, a technique for suppressing a high-frequency electrical propagation mode (slotline mode) by connecting ground electrodes on a substrate with a bonding wire or a ground shield has been disclosed. For examples, refer to Hao Xu, et. al, “Demonstration and Characterization of High-Speed Silicon Depletion-Mode Mach-Zehnder Modulators”, Journal of Selected Topics in Quantum Electronics, Vol. 20, No. 4, pp. 3400110, July/August 2014 and Xiaoguang Tu, et. al, “Silicon Optical Modulator with Shield Coplanar Waveguide Electrodes”, Optics Express, Vol. 22, No. 19, September 2014. According to another disclosed technique, in an optical modulator, in a portion in a length direction, ground electrodes are connected by vias and a metal layer, whereby the slotline mode in the optical modulator is suppressed. For an example, refer to Ran Ding, et. al, “High-Speed Silicon Modulator with Slow-Wave Electrodes and Fully Independent Differential Drive”, Journal of Lightwave Technology, Vol. 12, No. 12, pp. 2240-2247 June 2014. Further, a technology for propagating light through multiple optical waveguides in a thin-film LN optical modulator having a thin-film LN substrate has been disclosed. For an example, refer to Boynton, Nicholas, et. al, “A Heterogeneously Integrated Silicon Photonic/Lithium Niobate Travelling Wave Electro-Optic Modulator”, Optics Express, Vol. 28, No. 2, pp. 1868 January 2020.

### SUMMARY OF THE INVENTION

According to an aspect of an embodiment, an optical device includes: a substrate having a first surface and a second surface opposite to each other; an optical modulating unit provided in the substrate, at the first surface, the optical modulating unit having a plurality of electrodes for modulating an optical signal; a plurality of vias extending in a thickness direction of the substrate and connected to a plurality of ground electrodes included in the plurality of electrodes; and a second-surface electrode provided at the second surface of the substrate and connected to the plurality of vias.

An object and advantages of the invention will be realized and attained by means of the devices and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a cross-sectional view depicting an optical device according to an embodiment.

FIG. 2 is a top view depicting an example of a configuration of an optical modulator that includes the optical device.

FIG. 3A is a perspective view of an upper surface of the optical device according to the embodiment.

FIG. 3B is a perspective view of a lower surface of the optical device according to the embodiment.

FIG. 4 is a diagram depicting an example of a configuration in which the optical device of the embodiment is applied to a transceiver.

FIG. 5 is a cross-sectional view depicting an optical modulator according to a conventional technique.

FIG. 6A is a cross-sectional view depicting an occurrence of a slot line mode according to a conventional technique.

FIG. 6B is a cross-sectional view depicting the occurrence of the slot line mode according to a conventional technique.

FIG. 7 is a cross-sectional view of an example of a conventional technique for dealing with the slotline mode.

FIG. 8 is a cross-sectional view of an example of a conventional technique for dealing with the slotline mode.

FIG. 9A is a cross-sectional view of an example of a conventional technique for dealing with the slotline mode.

FIG. 9B is a cross-sectional view of the example of a conventional technique for dealing with the slotline mode.

FIG. 10 is a cross-sectional view depicting an example of a configuration of an EO polymer optical modulator according to a conventional technique.

FIG. 11 is a cross-sectional view depicting an example of a configuration of a thin-film LN optical modulator according to a conventional technique.

FIG. 12A is a graph depicting results of simulation of transmission characteristics of high-frequency electrical signals in the optical modulator.

FIG. 12B is a graph depicting results of simulation of transmission characteristics of high-frequency electrical signals in the optical modulator.

FIG. 13 is a cross-sectional view depicting a silicon photonics integrated thin film LN optical modulator according to a first example.

FIG. 14A is a diagram depicting an example of configuration of a thin-film LN optical modulator having a GSG configuration applied to a second example.

FIG. 14B is a diagram depicting an example of configuration of the thin-film LN optical modulator having the GSG configuration applied to the second example.

FIG. 14C is a cross-sectional view depicting an example of configuration of the thin-film LN optical modulator having the GSG configuration of the second example.

FIG. 15A is a cross-sectional view depicting an example of a configuration of an EO polymer optical modulator of a third example.

FIG. 15B is a cross-sectional view depicting an example of a configuration of the EO polymer optical modulator of the third example.

FIG. 16 is a cross-sectional view depicting an example of a configuration of a thin-film LN optical modulator of a fourth example.

FIG. 17 is a cross-sectional view depicting an example of a configuration of a silicon optical modulator of a fifth example.

FIG. 18 is a top view depicting an example of configuration of an optical modulator having segmented electrodes of a sixth example.

FIG. 19 is a top view depicting an example of a configuration of a transceiver of a seventh example.

FIG. 20A is a cross-sectional view depicting an electro-optical converting device of an eighth example.

FIG. 20B is a cross-sectional view depicting the electro-optical converting device of the eighth example.

FIG. 21A is a cross-sectional view depicting an electro-optical converting device according to the conventional techniques, for comparison to the eighth example.

FIG. 21B is a cross-sectional view depicting an electro-optical converting device according to the conventional techniques, for comparison to the eighth example.

### DESCRIPTION OF THE INVENTION

First, problems associated with the techniques above are discussed. While integrating high EO materials into silicon photonics devices may address challenges of silicon modulators, such as increasing modulation speed and reducing voltage, conversion from a CPW mode to the slot-line mode that accompanies signal propagation in the high-frequency electrode cannot be suppressed. With the conventional modulators, degradation of characteristics caused by electrodes cannot be suppressed and broadband implementation is not possible.

Embodiments of an optical device, a transmitter, a transceiver, and an electro-optical converting device according to the present disclosure are described in detail with reference to the accompanying drawings.

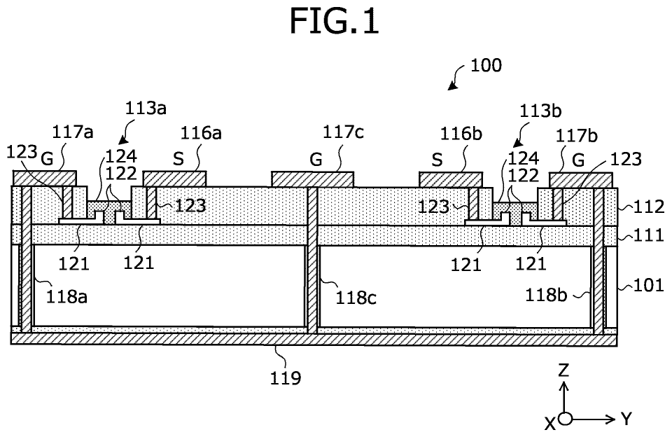

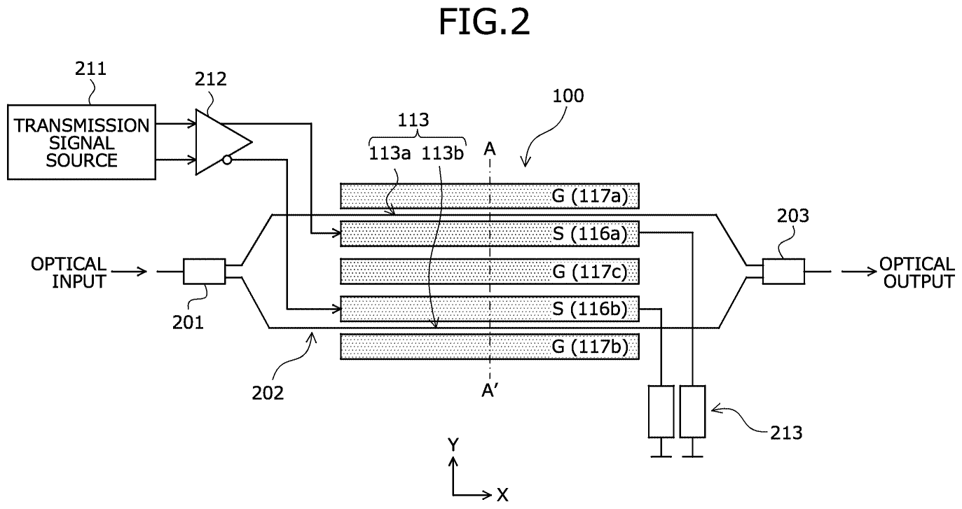

An example of a configuration of an optical device according to an embodiment is described. FIG. 1 is a cross-sectional view depicting the optical device according to the embodiment. FIG. 2 is a top view depicting an example of a configuration of an optical modulator that includes the optical device. FIG. 1 corresponds to a cross-sectional view along cutting line A-A′ in FIG. 2. The optical device of the embodiment, for example, using silicon photonics technology techniques, consists of a small-scale integration of optical devices on a silicon substrate.

FIG. 1 depicts an example of a configuration of an optical modulator 100 of an EO polymer type as an optical device. On a first surface (upper surface, surface) of a silicon substrate 101, a first silicon dioxide (SiO₂) layer 111 constituting a first insulating layer and a second SiO₂ layer 112 are stacked. On the first SiO₂ layer 111 (the second SiO₂ layer 112), a pair of optical modulating units (optical modulating devices) 113 (first optical modulating unit 113a, second optical modulating unit 113b) is provided.

Each of the optical modulating units 113 is constituted by silicon slab portions 121 doped with a p-type or n-type impurity to make the silicon slab portions 121 conductive and silicon rib portions 122 each having a protruding shape for guiding light, disposed opposite each other with a gap of a few hundred nanometers therebetween. An EO polymer portion 124 is disposed between and on the silicon slab portions 121 and between and on the silicon rib portions 122.

EO polymer materials have an electro-optical effect when cooled after a molecular orientation treatment called poling performed at a high temperature (for example, 150 degrees C. or higher) equal to or higher than the glass transition temperature of the material. In the configuration depicted in FIG. 1, a large portion of the light passes through the EO polymer portion 124 between the silicon rib portions 122; the EO polymer portion 124 functions as an EO polymer optical modulator.

In the first optical modulating unit 113a, one of the silicon slab portions 121 is connected to a signal electrode S (116a) on the second SiO₂ layer 112, through one of multiple vias 123 extending in a direction of thickness of the second SiO₂ layer 112. The other one of the silicon slab portions 121 is connected to a ground electrode G (117a) on the second SiO₂ layer 112, through one of the vias 123 extending in the direction of thickness of the second SiO₂ layer 112.

In the second optical modulating unit 113b, one of the silicon slab portions 121 is connected to a signal electrode S (116b) on the second SiO₂ layer 112, through one of the vias 123 extending in the direction of the thickness of the second SiO₂ layer 112. The other one of the silicon slab portions 121 is connected to a ground electrode G (117b) on the second SiO₂ layer 112, through one of the vias 123 extending in the thickness direction of the second SiO₂ layer 112.

On the second SiO₂ layer 112, a ground electrode G (117c) is provided between the pair of signal electrodes S (116a, 116b). In the example depicted in FIG. 1, the ground electrode G (117c) is disposed in a GSGSG electrode configuration, in a lateral direction Y of the substrate 101 on which the pair of optical modulating units 113 (113a, 113b) is provided.

In the substrate 101, vias 118 extending in a thickness direction Z of the substrate 101 are provided. Through the vias 118 extending in the thickness direction of the substrate 101, the second SiO₂ layer 112, and the first SiO₂ layer 111, the ground electrodes G (117) are in contact with a second-surface electrode (also referred to as “back electrode” or “ground electrode”) 119 provided at a second surface (lower surface) of the substrate 101, the second surface being opposite to the first surface of the substrate 101. The ground electrode G (117a) is connected to the back electrode 119 through the vias 118a. The ground electrode G (117b) is connected to the back electrode 119 through the vias 118b. The ground electrode G (117c) is connected to the back electrode 119 through the vias 118c.

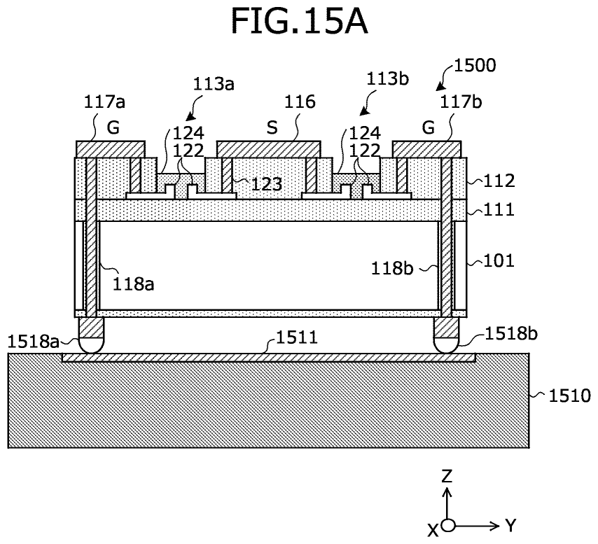

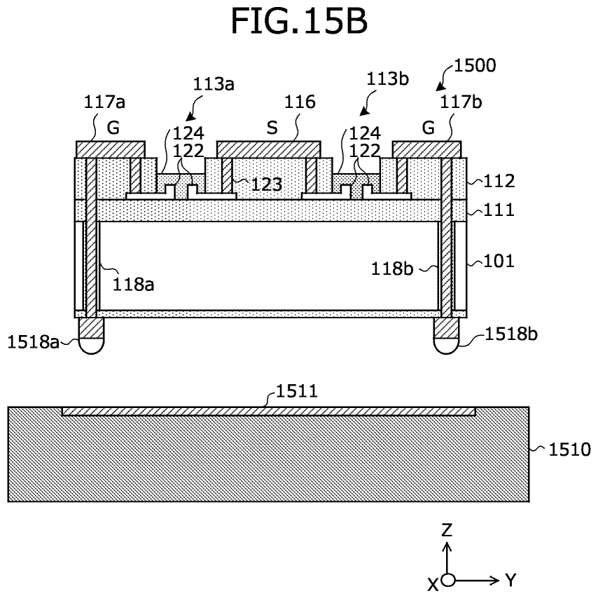

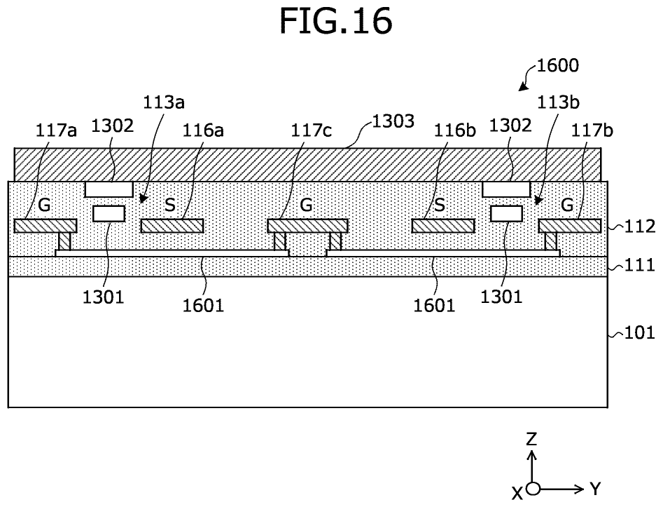

In the example, depicted in FIG. 1, the second-surface electrode 119 is provided at the second surface (lower surface, back surface) of the substrate 101. Without being limited hereto, as described hereinafter, the second-surface electrode 119 may be provided between the first surface (upper surface) and the second surface (lower surface) of the substrate 101, in other words, in the substrate 101 (for example, refer to FIG. 16). Furthermore, the second-surface electrode 119 may be provided on a substrate separate from the substrate 101 and by moving the substrate 101, the ground electrodes 117 of the substrate 101 may be connected a ground (for example, refer to FIG. 15A). As described, the second-surface electrode 119 is an electrode provided at a predetermined position along the thickness direction of the substrate 101, toward the second surface of the substrate 101, not at a surface position on the first surface (upper surface) of the substrate 101.

FIG. 2 corresponds to a top view of the optical modulator 100 in FIG. 1 and depicts a Mach-Zehnder optical modulator. FIG. 2 further depicts general components of the optical modulator. Optical input is split into two branches by an optical splitter 201 and guided by a pair of optical waveguides 202. Each of the pair of optical waveguides 202 has a predetermined length in a longitudinal direction X; the two branches are combined by the optical combiner 203 and output.

The optical modulating units 113 depicted in FIG. 1 are provided along the optical waveguides 202 of the predetermined length while at ends of the first optical modulating unit 113a, the ground electrode G (117a) and the signal electrode S (+)116a are provided. At ends of the second optical modulating unit 113b, the signal electrode S (−)116b and the ground electrode G (117b) are provided. Further, the ground electrode G (117c) is provided between the signal electrode S (+)116a and the signal electrode S (−)116b.

A signal of a transmission signal source 211 is supplied to respective ends of the signal electrode S (+)116a and the signal electrode S (−)116b through a driver amplifier 212. Other ends of the signal electrode S (+)116a and the signal electrode S (−)116b are terminated by termination resistors 213, respectively.

The optical input, which is output by a tunable laser light source or the like is split into branches by the optical splitter 201 and guided by the pair of optical waveguides 202. The light guided by the optical waveguides 202 is optically modulated by the pair of optical modulating units 113 (113a, 113b) based on a signal of the transmission signal source 211, is combined by the optical combiner 203 and thereafter, is optically output as modulated signal light.

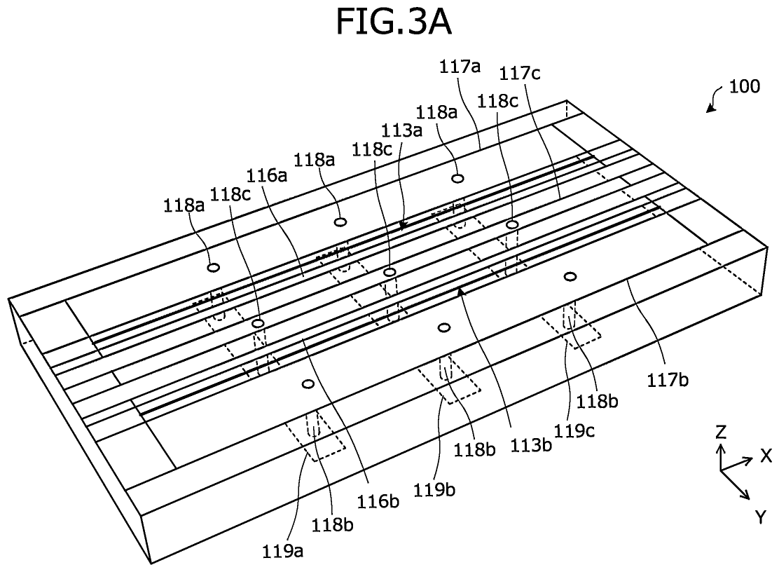

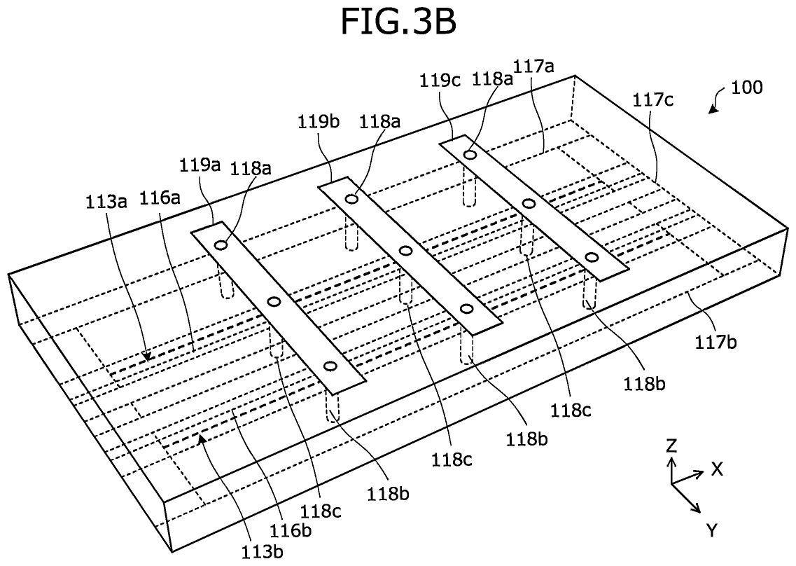

FIG. 3A is a perspective view of the upper surface of the optical device according to the embodiment and FIG. 3B is a perspective view of the lower surface of the optical device according to the embodiment. Perspective views of the optical modulator 100 in FIG. 1 are depicted.

As depicted in FIG. 3A, the three ground electrodes G (117a to 117c) at the upper surface are connected, respectively, to first ends of the vias 118 (118a, 118b, 118c) provided at different positions (three locations) in the length direction.

The vias 118 (118a, 118b, 118c) extend in the thickness direction of the substrate 101 and second ends of the vias 118 are connected to the back electrode 119 provided at the lower surface and depicted in FIG. 3B. In the example depicted in FIG. 3B, at different positions in the longitudinal direction X of the ground electrodes G (117a to 117c), the back electrode 119 includes three back electrodes (119a, 119b, 119c) provided along the lateral direction Y. Without limitation hereto, the back electrode 119 may be provided in an entire area of the back surface of the optical modulator 100.

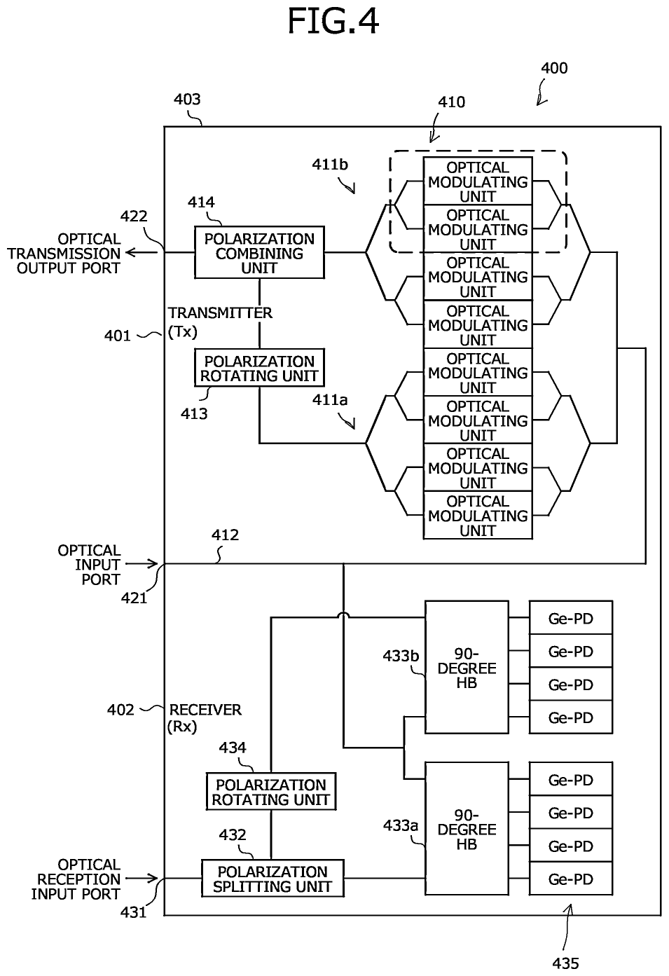

FIG. 4 is a diagram depicting an example of a configuration in which the optical device of the embodiment is applied to a transceiver. A transceiver 400 is fabricated on a silicon substrate 403 using silicon photonics technology, together with the optical waveguides, optical functional devices. A transmitter 401 consists of an optical integrated device for polarization multiplexed coherent optical transmission and is fabricated by silicon photonics technology. The transceiver 400 depicted in FIG. 4 is provided on the silicon substrate 403 together with the transmitter 401 and a receiver 402.

An optical modulating unit 410 (corresponds to the optical modulator 100 in FIG. 1) of the transmitter 401 is a Mach-Zehnder modulator having multiple modulators 411 and an optical waveguide 412. The optical modulating unit 410 includes, for example, two parent Mach-Zehnder interferometers 411 (411a, 411b) roughly classified according to X- and Y-polarized waves, and four child Mach-Zehnder interferometers, for eight branches of the optical waveguide 412. In FIG. 4, a portion indicated by a dashed line corresponds to the optical modulator 100 (the pair of optical modulating units 113a, 113b) depicted in FIGS. 1 and 2.

In the transmitter 401, light from the non-depicted tunable laser light source is input to an end surface of the optical waveguide 412, the end surface constituting an optical input port 421; a portion of the light is branched and output to the optical modulating unit 410. The optical modulating unit 410 performs a desired optical modulation and a polarization rotating unit 413 rotates the polarization of the modulated signal light from one of the parent modulators (one of the parent Mach-Zehnder interferometers) 411a 90 degrees. A polarization combining unit 414 combines the modulated signal light from the one of the parent modulators 411a and the modulated signal light of the other one of the parent modulators (the other one of the parent Mach-Zehnder interferometers) 411b (X+Y), the combined light being emitted as modulated signal light from an optical transmission output port 422 constituted by an end surface of the optical waveguide.

In the receiver 402, signal light received from an optical transmission fiber of an installed optical transmission line is input to an optical reception input port 431 constituted by an end surface of the optical waveguide, a polarization splitting unit 432 splits the received signal light into two polarization components (X, Y). Of the two polarization components of the received signal light, one is input to a 90-degree hybrid (HB) device 433a and the other is input to a 90-degree hybrid device 433b via the polarization rotating unit 434.

On the other hand, a portion of the light input from the optical input port 421 constituted by said end surface of the optical waveguide is branched and, similarly, is input to the two 90-degree hybrid devices 433a, 433b. A portion of the light from the tunable laser light source is used as local light of the receiver 402. The 90-degree hybrid devices 433 (433a, 433b) of the receiver 402 have a function of converting a phase state of the received signal light into optical intensity, using the local light as reference light. The optical intensity output by the 90-degree hybrid devices 433 (433a, 433b) is detected and output by eight Ge-doped photodetectors (PDs) 435.

According to the transceiver 400 depicted in FIG. 4, the transmitter 401 and the receiver 402 are both provided on the silicon substrate 403, thereby enabling size and cost reductions.

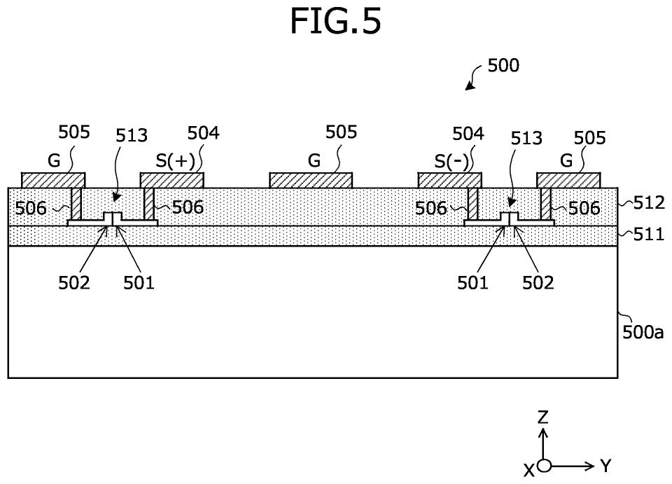

Here, the conventional techniques and problems that led to the present invention are explained with reference to FIGS. 5 to 11.

FIG. 5 is a cross-sectional view depicting an optical modulator according to a conventional technique. In a conventional optical modulator 500, a first SiO₂ layer 511 and a second SiO₂ layer 512 are formed on a silicon substrate 500a; optical modulating units 513 are formed in portions of the first SiO₂ layer 511 and the second SiO₂ layer 512. Each of the optical modulating units 513 has n-type doped regions 502 and p-type doped regions 501 doped with a p-type dopant and an n-type dopant. The p-type doped regions 501 and the n-type doped regions 502 are connected to electrodes 504, 505 through vias 506, respectively.

By connecting a pn junction portion to a silicon optical waveguide and controlling the carrier density by the voltage applied to the electrodes 504 and 505, the refractive index of the pn junction portion changes, and the phase of the light passing through the pn junction portion changes. The electrodes include signal electrodes S (504) and ground electrodes G (505) for operating transmission.

While not depicted, the optical modulator 500 includes a transmission signal source, a driver amplifier, an optical splitter, a pair of optical waveguides, an optical combiner, and termination resistors similar to those in FIG. 2. In configuration example depicted in FIG. 5, in the lateral direction Y in which the pair of optical modulating units 513 are provided, the electrodes are disposed in an order of GSGSG. When the voltages of the two signal electrodes S (504) have opposite polarities, the direction of change in the optical phase changes. The phase of the light split by the optical splitter is delayed by one of the optical modulating units 513 and advanced by the other one of the optical modulating units 513. As a result, a phase difference is generated, the optical combiner combines the light thereby causing the light to interfere, enabling modulation of the phase and intensity of the light and output of modulated light.

The transmission signal source outputs an electrical signal; the driver amplifier amplifies the voltage to a voltage required by the optical modulating unit and thereafter, the amplified signal is propagated, in an X-axis direction of FIG. 5, to terminals of the signal electrodes S (504). To properly convert an electrical modulation signal into an optical modulation signal, the signal electrodes S (504) need to have an electric field correctly propagating from the driver amplifier to the termination resistors.

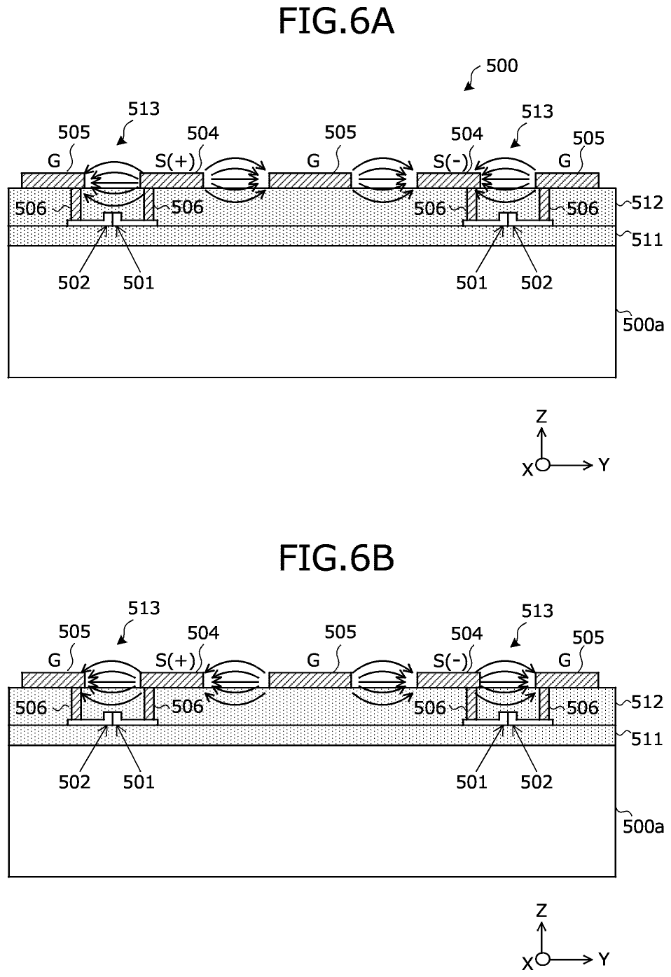

FIGS. 6A and 6B are cross-sectional views depicting the occurrence of the slot line mode according to a conventional technique. FIGS. 6A and 6B show lines of electric force of the optical modulating units 513 described in FIG. 5. The prior art has problems in propagating high-frequency signals of a few tens of GHz. As depicted in FIG. 6A, when differential electrical signals are transmitted, the desired transmission mode is one in which the potential of one signal electrode S (+) 504 of the GSGSG electrode configuration is higher than the potential of the ground electrodes 505, and the potential of the other signal electrode S (−) 504 is lower than the potential of the ground electrodes 505, as depicted in FIG. 6A. This transmission mode is usually called coplanar transmission mode (CPW mode).

However, since a pn junction optical modulating unit is formed only on one side of each GSG electrode configuration, and the pair of optical modulating units 513 has poor symmetry, it is known that, in actuality, a high-frequency electrical propagation mode occurs as shown in FIG. 6B. This is called slotline mode. When this high-frequency electrical propagation mode conversion occurs, electrical signals cannot be transmitted properly and as a result, optical signals cannot be modulated properly either, resulting in degradation of optical modulation characteristics. As conventional techniques for dealing with such a slotline mode, for example, Hao Xu, et.al, “Demonstration and Characterization of High-Speed Silicon Depletion-Mode Mach-Zehnder Modulators”, Xiaoguang Tu, et.al, “Silicon Optical Modulator with Shield Coplanar Waveguide Electrodes”, Ran Ding, et.al, “High-Speed Silicon Modulator With Slow-Wave Electrodes and Fully Independent Differential Drive” above have been disclosed.

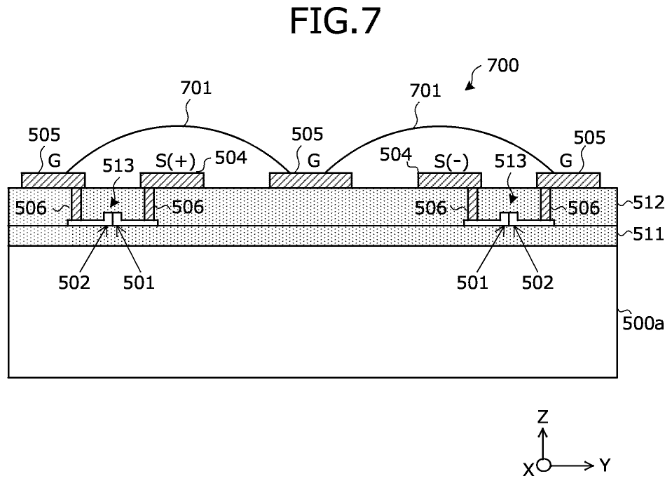

FIGS. 7, 8, 9A, and 9B are cross-sectional views of examples of conventional techniques for dealing with the slotline mode. Components of the optical modulating units depicted in FIGS. 7 to 9B are assigned the reference numerals used in FIG. 5. First, in an optical modulator 700 (corresponds to Hao Xu, et.al, “Demonstration and Characterization of High-Speed Silicon Depletion-Mode Mach-Zehnder Modulators”) depicted in FIG. 7, the ground electrodes G (505) of the GSGSG electrodes are connected by a bonding wire 701 and have a same potential. As a result, transition from the CPW mode to the slotline mode is suppressed.

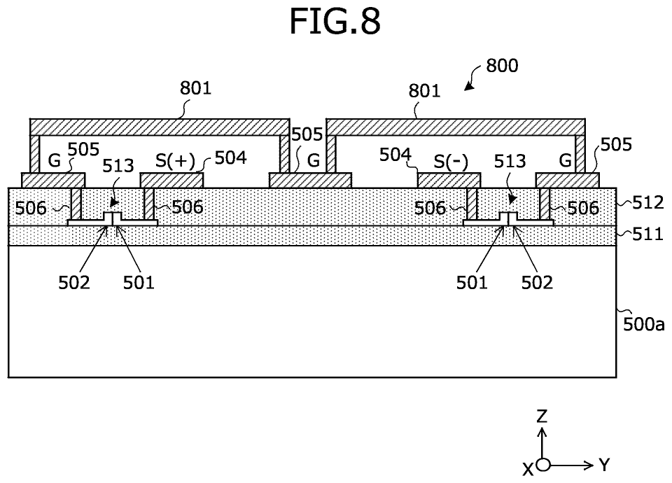

Further, in an example of a configuration of an optical modulator 800 (corresponds to Xiaoguang Tu, et.al, “Silicon Optical Modulator with Shield Coplanar Waveguide Electrodes”) depicted in FIG. 8, the ground electrodes G (505) of the GSGSG electrodes are connected by a ground shield 801, whereby the potential thereof is the same. As a result, transition from the CPW mode to the slotline mode is suppressed.

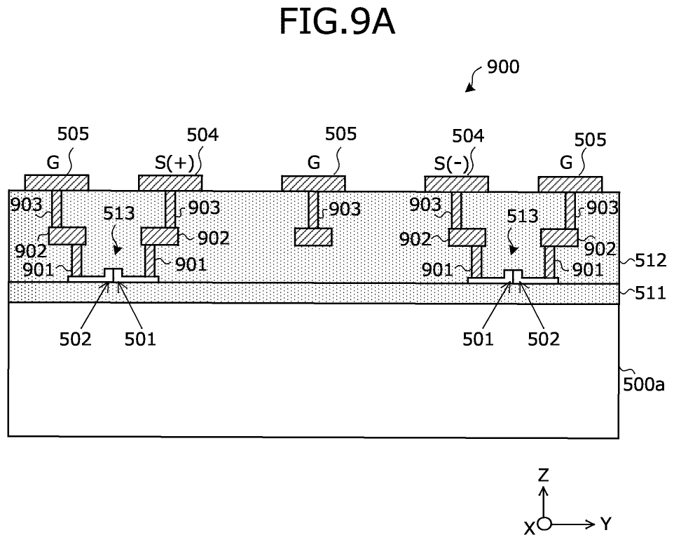

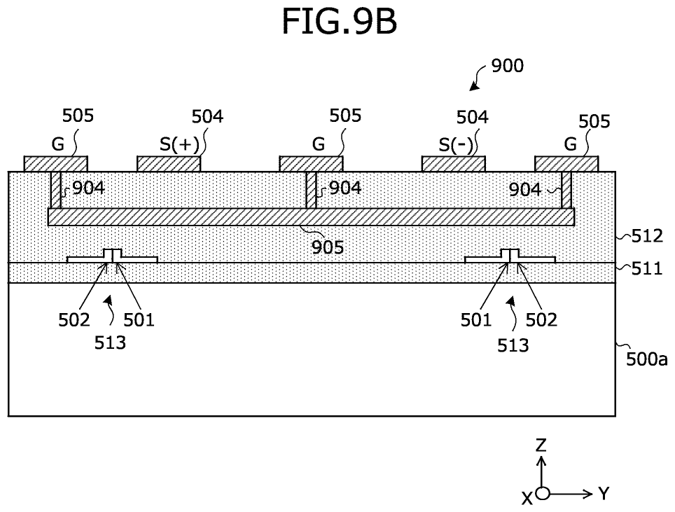

Further, in an example of a configuration of an optical modulator 900 (corresponds to Ran Ding, et.al, “High-Speed Silicon Modulator With Slow-Wave Electrodes and Fully Independent Differential Drive”) depicted in FIG. 9, the optical modulator 900 has a structure in which a cross-section thereof is not uniform, and in the silicon layers 511, 512 in the optical modulator 900, the structure in FIG. 9A and the structure in FIG. 9B are repeatedly disposed periodically in the longitudinal direction X.

As depicted in FIG. 9A, at predetermined positions in the longitudinal direction X of the optical modulator 900, the optical modulating units 513 are connected to first metal layers 902 by vias 901, and second metal layers 504, 505 connected by vias 903 on the first metal layers 902 are formed. The second metal layers 504, 505 are used as the signal electrodes 504 and the ground electrodes 505 for providing modulated electrical signals from an external source.

Further, along the longitudinal direction X of the optical modulator 900, at positions different from arrangement positions in FIG. 9A, as depicted in FIG. 9B, the ground electrodes 505 of the GSGSG electrodes are connected by vias 904 and a third metal layer 905.

In the configuration depicted in FIG. 9A, while conversion of an electrical signal to the slotline mode occurs, the configuration in FIG. 9B suppresses the slotline mode by a same principle as that in an instance of FIG. 7 (Hao Xu, et.al, “Demonstration and Characterization of High-Speed Silicon Depletion-Mode Mach-Zehnder Modulators”) and FIG. 8 (Xiaoguang Tu, et.al, “Silicon Optical Modulator with Shield Coplanar Waveguide Electrodes”), resulting in the CPW mode. However, along the longitudinal direction X of the optical modulator 900, in an interval of the configuration depicted in FIG. 9B, electrical signals cannot be supplied to the optical modulator 900 (the optical modulating units 513) and therefore, optical modulation is impossible and the modulation efficiency of the modulator as a whole decreases by the length of the interval x the placement period in FIG. 9B.

As described above, the silicon optical modulator works on the principle of changing the refractive index of the pn junction by changing the carrier density of the pn junction by an external electric field and modulating the phase of the light passing through.

However, it is known that there is a limit to the modulation speed in this operating principle and while this operating principle may cope with up to, for example, about 64 Gbaud, application to higher-speed transmission is difficult. Further, the degree of phase modulation of light relative to voltage is small, making it necessary to amplify and thereby increase the amplitude of the modulating electrical signals, which places a limit on the extent to which the voltage may be reduced. To address these issues, development of modulator materials other than silicon is being actively pursued.

On the other hand, silicon photonics-based optical devices (optical waveguide, optical combiner, optical splitter, Ge optical receiver, 90-degree hybrid, etc.) such as the transceiver 400 depicted in FIG. 4 have an advantage in that they may be compactly integrated on the silicon substrate 403. Therefore, the method of integrating modulator materials other than silicon on a silicon substrate is promising.

Specifically, this is a technique in which only the optical modulating unit 410 in a silicon photonics integrated circuit is integrated with a material capable of high-speed modulation and having a high electro-optic constant (called a high EO coefficient). Materials with high EO coefficients that are being considered as candidates include EO polymers, thin-film lithium niobate (LN), lanthanum-doped lead zirconate titanate (PLZT), and BTO (barium titanate).

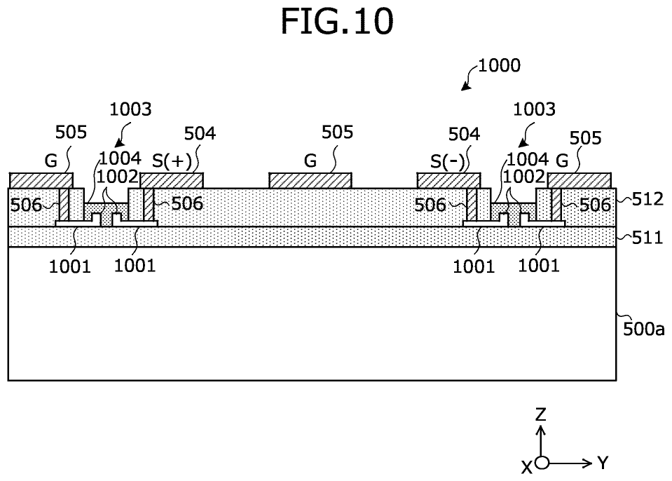

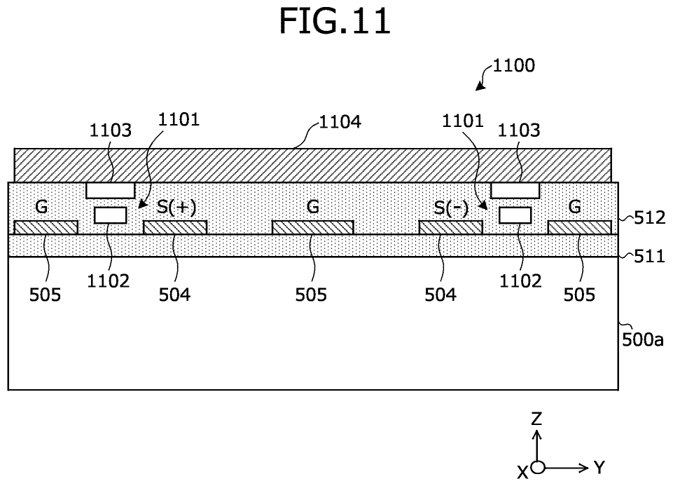

FIG. 10 is a cross-sectional view depicting an example of a configuration of an EO polymer optical modulator according to a conventional technique and FIG. 11 is a cross-sectional view depicting an example of a configuration of a thin-film LN optical modulator according to a conventional technique.

In FIG. 10, components identical to those depicted in FIG. 5 are given the same reference numerals used in FIG. 5. Optical modulating units 1003 of an EO polymer optical modulator 1000 in FIG. 10 each have silicon slab portions 1001 doped with a p-type or n-type impurity to make the silicon slab portions 1001 conductive and silicon rib portions 1002 each having a protruding shape for guiding light. The silicon rib portions 1002 are disposed opposite each other with a gap of a few hundred nanometers therebetween and an EO polymer portion 1004 is disposed between and on the rib portions 1002.

An EO polymer has an electro-optical effect when cooled after a molecular orientation treatment called poling is performed at a high temperature (for example, 150 degrees C. or higher) equal to or higher than the glass transition temperature of the material. In the configuration depicted in FIG. 10, a large portion of the light passes through the EO polymer portion 1004 between the silicon rib portions 100, the EO polymer portion 1004 functioning as the EO polymer optical modulator 1000. A method of manufacturing the EO polymer optical modulator 1000 using such silicon photonics integration is generally to apply a dissolved EO polymer solution to a portion of the EO polymer portion 1004 from above the silicon substrate 500a using a precision dispenser or the like, and then cure the EO polymer solution.

Further, an optical modulating unit 1101 of a thin-film LN optical modulator 1100 in FIG. 11 includes the electrodes 504, 505 and two optical waveguides 1102, 1103 in a vertical direction, on the silicon substrate 500a. A thin-film LN substrate 1104 is bonded on the electrodes 504, 505 and the optical waveguides 1102, 1103.

In the thin-film LN substrate 1104, an insulating film containing SiO₂ or the like is formed on an LN substrate or the like and a thin-film LN layer is formed thereon; the thin-film LN layer is bonded so that the thin-film LN layer is at the bottom. The LN substrate and the propagation light are disclosed in Boynton, Nicholas, et al, “A Heterogeneously Integrated Silicon Photonic/Lithium Niobate Travelling Wave Electro-Optic Modulator” above.

Here, in FIG. 11, light input through a tapered optical transition structure (not shown) travels in a direction X of view of the drawing and transitions from optical waveguides 1102 to optical waveguides 1103, and most of the light propagates while seeping into the LN portion, functioning as the thin-film LN optical modulator 1100. After undergoing optical phase modulation in the thin-film LN substrate 1104, the light travels back to the optical waveguides 1102 and is output. The thin-film LN substrate 1104 is integrated onto the silicon substrate 500a on which the first SiO₂ layer 511 and the second SiO₂ layer 512 are stacked, for example, by a technique such as microtransfer printing.

As depicted in FIGS. 10 and 11, integrating high EO materials into silicon photonics devices may address challenges of silicon modulators, such as increasing modulation speed and reducing voltage. However, even in optical modulators that use high EO materials, the problem of conversion from a CPW mode to the slot-line mode that accompanies signal propagation in the high-frequency electrode occurs.

However, with the conventional techniques (corresponds to Hao Xu, et. al, “Demonstration and Characterization of High-Speed Silicon Depletion-Mode Mach-Zehnder Modulators”, Xiaoguang Tu, et.al, “Silicon Optical Modulator with Shield Coplanar Waveguide Electrodes”, Ran Ding, et.al, “High-Speed Silicon Modulator With Slow-Wave Electrodes and Fully Independent Differential Drive”) depicted in FIGS. 7 to 9B, dealing with the problem of the occurrence of the slotline mode is difficult. A reason for this is that, in all of these conventional techniques, of the GSGSG electrodes at the upper surfaces of the optical modulating units 513, the ground electrodes 505 are connected.

Further, in modulators that use high EO materials, such as in both the EO polymer optical modulator 1000 depicted in FIG. 10 and the thin-film LN optical modulator 1100 depicted in FIG. 11, formation is by applying or adhering a different material from the upper surface of the silicon substrate 500a. In an instance in which the EO polymer optical modulator 1000 is fabricated, the interval of the electrodes 504, 505 of the GSGSG electrodes, that is, an interval in the lateral direction Y between regions (the optical modulating units 513) where an EO polymer solution is applied is a few tens of microns wide. Therefore, in actuality, when the EO polymer solution is applied, the solution also spreads to portions of the electrodes 504, 505, whereby wire bonding becomes difficult.

Further, in the thin-film LN optical modulator 1100 depicted in FIG. 11, the electrodes 504, 505 are exposed at the upper surface and thus, arrangement of wire bonding in FIG. 7 and the shield ground in FIG. 8 is difficult. Further, in the thin-film LN optical modulator 1100, the optical waveguides 1102, 1103 and the thin-film LN substrate 1104 have to be in close proximity. Thus, disposing a structure, such as a metal layer for connecting the ground electrodes 505, in an inner layer (the second SiO₂ layer 512) in the optical modulator 900 depicted in FIG. 9, at the upper side of the optical modulator 900, is difficult.

As described, in the optical modulators of the conventional techniques, in an instance of a structure in which dissimilar materials are integrated on a silicon substrate, the occurrence of high-frequency electrical propagation mode conversion (slotline mode) cannot be suppressed.

Here, the conventional techniques and the embodiment are compared. In the optical device of the embodiment, as described with reference to FIG. 1, the EO polymer portion 124 is formed on the silicon substrate 101 as the optical modulator 100 in which dissimilar materials are integrated. Furthermore, in the optical modulator 100 of the embodiment, the vias 118 (118a, 118b, 118c), which extend in the thickness direction of the first and second SiO₂ layers 111, 112, are formed in each of the ground electrodes G (117; 117a to 117c) of the GSGSG configuration. Further, the vias 118 are connected to the back electrode 119 of the silicon substrate 101.

For example, the vias 118 are formed by etching the silicon substrate 101 and a metal material is embedded therein. Further, an insulating film having a thickness of not more than a few microns is formed along a periphery of the openings of the vias 118 for insulation from the silicon substrate 101. Further, wiring is performed after an insulating film for insulating the back electrode 119 from the silicon substrate 101 is formed.

The vias 118, in general, are called through silicon vias (TSVs), have a diameter ranging from a few microns to several tens of microns, and are embedded with copper; and the insulating film contains SiO₂ and has a thickness of not more than a few microns. The silicon substrate 101 is polished by a chemical mechanical polishing (CMP) method to have a thickness of about 100 microns, whereby the vias 118 may be formed in the silicon substrate 101.

In silicon photonics devices such as the optical modulator 100 of the embodiment, optical waveguides, optical modulators, optical receivers, etc. are all formed in the silicon substrate 101, about a few microns from the surface of the silicon substrate 101. Thus, with the conventional techniques, there is no need to reduce the thickness of the silicon substrate itself and, in general, reduction of the thickness is not performed. On the other hand, in semiconductor memory devices and the like, to increase capacity, etc., a configuration is used in which the thickness of the silicon substrate is reduced, TSVs are formed and stacked three-dimensionally.

In the embodiment, application of a technique of thinning a silicon substrate to a silicon photonics substrate is realized. Further, in the embodiment, the ground electrodes G (117) of the GSGSG electrodes are connected to the back surface side of the silicon substrate 101 by a GND bridge using TSVs and thus, integration of dissimilar materials at the surface of the silicon substrate 101 may be easily realized.

Next, suppression of high-frequency electrical propagation mode conversion by the optical modulator 100 of the embodiment was verified by electromagnetic simulation. A perspective view of the optical modulator 100 depicted in FIGS. 3A and 3B described above corresponds to a simulation model. In the simulation model, as depicted in FIGS. 3A and 3B, the vias 118 (118a, 118b, 118c), which extend in the thickness direction of the silicon substrate 101, are used to connect the ground electrodes G (117; 117a to 117c) of the GSGSG electrodes to each other by the back electrode 119 of the silicon substrate 101. For example, it was assumed that the diameter of each of the vias 118 is 10 μm, the thickness of the silicon substrate is 100 μm, the thickness of the insulating film is 1 μm, and a conductive material is copper, and the electrical conductivity of copper was used.

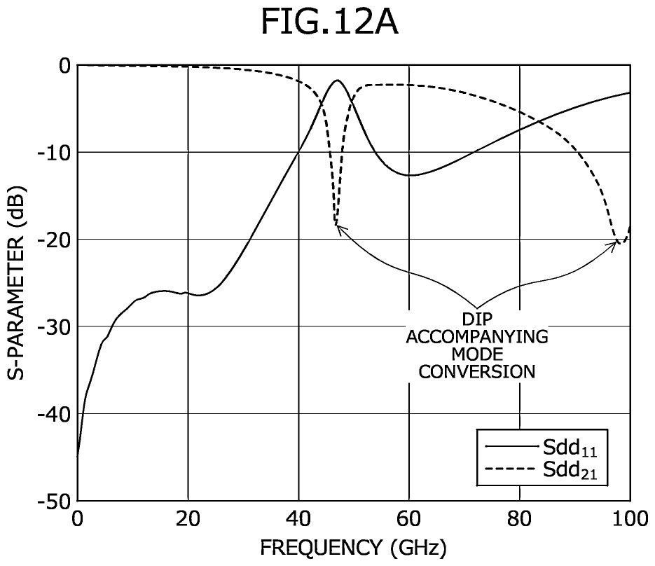

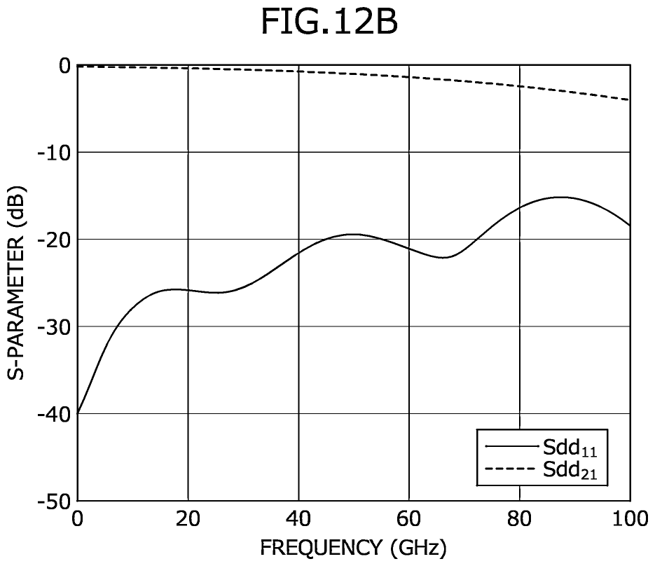

FIGS. 12A and 12B are graphs depicting results of simulation of transmission characteristics of high-frequency electrical signals in the optical modulator. FIG. 12A shows results of simulation of transmission characteristics of high-frequency electrical signals in an instance free of a GND bridge using TSVs and corresponds to the conventional techniques. FIG. 12B shows results of simulation of transmission characteristics of high-frequency electrical signals in an instance of a GND bridge using TSVs and corresponds to the embodiment. In FIGS. 12A and 12B, a horizontal axis indicates frequency, and a vertical axis indicates an S-parameter. Further, the optical modulator 100 exhibits operating transmission characteristics Sdd₂₁ and operating reflection characteristics Sdd₁₁ for differential signal transmission.

In FIG. 12A, while large dips occur in the transmission characteristics near 45 GHz and 95 GHz, in FIG. 12B, the occurrence of the dips is suppressed. According to the embodiment depicted in FIG. 12B, it is shown that the high frequency electrical propagation mode (slot line mode) that occurs in the conventional technique depicted in FIG. 12A may be suppressed. The phenomenon in which a dip occurs in the frequency characteristics when high-frequency electrical propagation mode conversion occurs is also exhibited in Hao Xu, et.al, “Demonstration and Characterization of High-Speed Silicon Depletion-Mode Mach-Zehnder Modulators” and Xiaoguang Tu, et.al, “Silicon Optical Modulator with Shield Coplanar Waveguide Electrodes”.

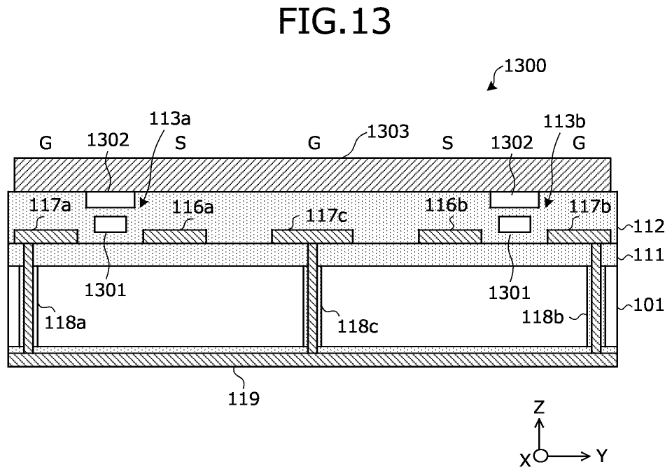

Next, examples of the optical modulator are described. FIG. 13 is a cross-sectional view depicting a silicon photonics integrated thin film LN optical modulator according to a first example. In FIG. 13, the SiO₂ layer 112 includes the first and second optical modulating units 113a, 113b, which each have upper and lower optical waveguides 1301, 1302. In a silicon photonics integrated thin film LN optical modulator 1300 of the first example as well, the vias 118, which are TSVs, are formed in the substrate 101 and the ground electrodes G (117) of the GSGSG electrodes are connected by the back electrode (ground electrode) 119 of the substrate 101, in a similar manner as described above.

Here, at the upper side of the substrate 101, the upper side is as depicted in FIG. 11 and thus, a thin film LN chip 1303 may be implemented at the upper side of the substrate 101, using a technique such as microtransfer printing without affecting the formation of the vias 118. The thin film LN chip 1303 may be implemented by a method such as microtransfer printing. Further, a substrate in which a thin film LN is formed at the wafer stage may also be bonded to the upper surface of the substrate 101. Formation of the vias 118 and the back electrode 119 may be performed before or after the bonding of the thin film LN chip 1303.

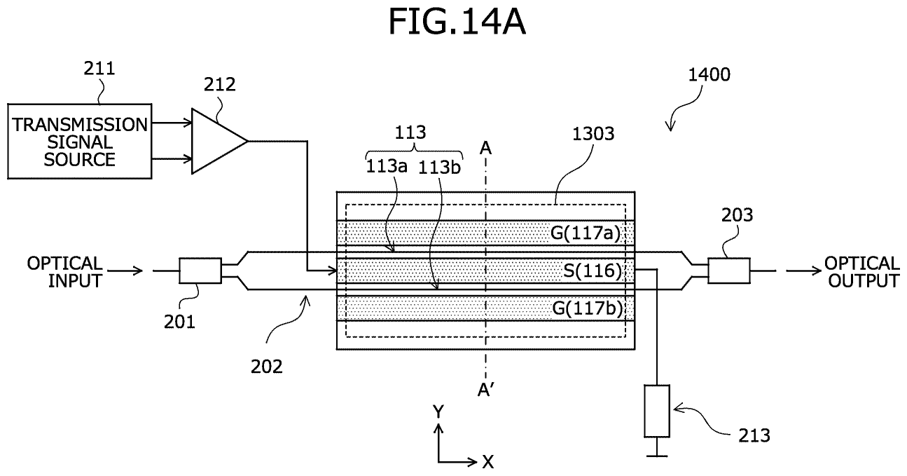

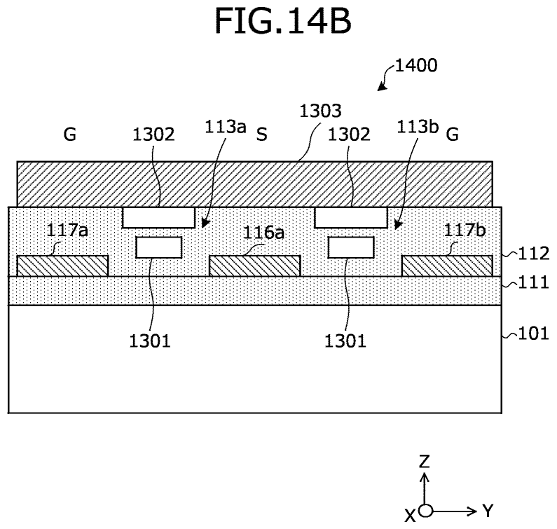

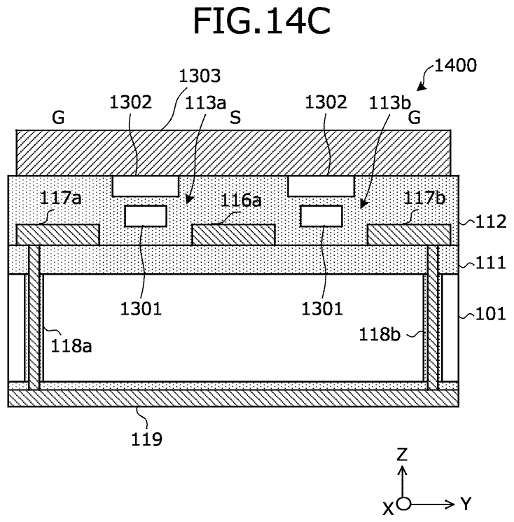

FIGS. 14A and 14B are diagrams depicting an example of configuration of a thin-film LN optical modulator having a GSG configuration applied to the second example. FIG. 14A is a top view of a Mach-Zehnder optical modulator and FIG. 14B is a cross-sectional view along cutting line A-A′ in FIG. 14A. In FIGS. 14A and 14B, components identical to those depicted in FIG. 2 are given the same reference numerals used in FIG. 2.

As for a material property, an EO polymer or LN may delay or advance the phase of light depending on the direction in which an electric field is applied. Thus, a Mach-Zehnder optical modulator 1400 having a GSG configuration depicted in FIGS. 14A and 14B may be configured.

An electrical modulation signal is a single output and drives the signal electrode S (116) at a center of the optical modulator. Electric field is generated in a direction to the ground electrodes G (117a, 117b) located on either side of the signal electrode S (116). This results in a push-pull drive in which the phase changes in opposite directions, and even the GSG configuration operates as an optical modulator. In this instance, the ground electrodes G (117a, 117b) are equivalent in structure to the signal electrode S (116) in the center of the drawing and ideally no high-frequency propagation mode conversion occurs. However, in actuality, imperfections such as manufacturing variations and bent electrode structures may impair uniformity and cause degradation in the propagation of high-frequency electrical signals.

An important characteristic of the optical modulator 1400 is the amount of phase conversion per unit length. The voltage required to change the phase of light by 180 degrees is called the half-wave voltage and is defined as voltage x length. To reduce the driving voltage for lower power consumption, while it is effective to increase the length of the optical modulator 1400 in the X-axis direction, this will increase the size of the optical modulator 1400. When the driver amplifier 212 that drives the optical modulator 1400 depicted in FIG. 14A and other components are disposed on the substrate 101, the overall arrangement of the device may be advantageous in order to cope with size increases of the optical modulator 1400 by bending the high-frequency electrode structure from the driver amplifier 212 to the optical modulator 1400. In this instance, even with the GSG electrode configuration, at the bent portions, the propagation distance of high-frequency electrical signals is different between the left and right grounds and thus, asymmetry occurs.

FIG. 14C is a cross-sectional view depicting an example of a configuration of the thin-film LN optical modulator having the GSG configuration of the second example. In the thin-film LN optical modulator 1400 of the second example, as depicted in FIG. 14C, the left and right ground electrodes G (171a, 117b) are connected to a ground by the back electrode 119 of the substrate 101 through the vias 118a, 118b. As a result, for example, even in an instance of a bent electrode structure, the left and right ground electrodes G (171a, 117b) are connected, thereby enabling mode conversion to be suppressed.

FIGS. 15A and 15B are cross-sectional views depicting an example of a configuration of an EO polymer optical modulator of a third example. In the configuration examples described above, of the electrodes of the GSGSG configuration of the optical modulator, three of the ground electrodes G (117a to 117c) or two of the ground electrodes G (117a, 117b) of the GSG configuration are connected by the back electrode 119 of the substrate 101. In the third example, the ground electrodes G are connected to each other on another substrate (second substrate) 1510 separate from the substrate 101 of the optical modulator 1500.

As depicted in FIG. 15A, the vias 118a, 118b and conductive bumps 1518 (1518a, 1518b) are provided at the back surface of the substrate 101. In the example depicted in FIG. 15A, the bumps 1518 use copper pillars and solder caps. At the back side of the substrate 101, the other substrate (second substrate) 1510 is disposed with the upper surface thereof facing the back surface of the substrate 101. On the other substrate 1510, a ground electrode 1511 for conduction of the bumps 1518 (1518a, 1518b) is provided. Further, the bumps 1518 of the substrate 101 of the optical modulator 1500 are connected on the other substrate 1510. Even with this configuration, by the principle described above, mode conversion in high-frequency signal propagation may be suppressed.

As described, the substrate 101 of the optical modulator 1500 requires the provision of the other substrate 1510 when the optical modulator is, for example, the EO polymer optical modulator 1500 as shown in FIG. 15A. To function as an optical modulator, the EO polymer optical modulator 1500 with silicon photonics integration requires a poling treatment, which is a molecular orientation treatment for inducing an electro-optical effect, after an EO polymer solution is applied on the silicon waveguides.

To perform poling with the GSG electrode configuration, voltage has to be applied to the EO polymer portion 124. For the voltage application during poling, it is necessary to apply a voltage to one of the ground electrodes G (117a) of the GSG configuration, leave the signal electrode S (116) unconnected, and ground the other ground electrode G (117b). Therefore, the ground electrodes G (117a, 117b) on both sides of the GSG electrode configuration have to be electrically separated only during the poling process.

FIG. 15B depicts a state in which the other substrate 1510 is apart from the substrate 101 of the optical modulator 1500. The poling treatment is performed while the other substrate 1510 is apart from the substrate 101 of the optical modulator 1500 depicted in FIG. 15B. Thereafter, as depicted in FIG. 15A, the substrate 101 of the optical modulator 1500 is mounted on the other substrate 1510, whereby the ground electrodes G (117a, 117b) on both sides of the GSG configuration may be connected to a ground and when used as the optical modulator 1500, high-frequency propagation mode conversion may be suppressed.

In the description above, the bumps 1518 are described to be formed at a second side of the substrate 101. Without limitation hereto, the bumps 1518 may be formed on the second substrate 1510, at positions facing the vias 118. Furthermore, ball bumps may be placed on the second substrate 1510, at positions facing the vias 118 and thereafter, the substrate 101 may be mounted thereon.

FIG. 16 is a cross-sectional view depicting an example of a configuration of a thin-film LN optical modulator of a fourth example. In the examples described above, the ground electrodes 117 of the upper surface of the substrate 101 are connected to each other by the back electrode 119 or the ground electrode 1511 of the back side of the substrate 101, through the vias 118. In a thin-film LN optical modulator 1600 of the fourth example, the optical modulating unit is formed in a vicinity of an LN substrate 1303. On the upper side of the substrate 101, the ground electrodes 117 of the GSGSG configuration or the GSG configuration are connected by ground wiring 1601.

In silicon modulators and EO polymer optical modulators, a silicon on insulator (SOI) substrate is used as the substrate 101, and a silicon layer 1601 above the first SiO₂ layer 111 on the upper side of the SOI substrate is etched to form the modulators. In the thin-film LN optical modulator 1600 of the fourth example, the etched silicon layer 1601 is doped, thereby making the silicon layer 1601 conductive and connecting grounds in the first and second SiO₂ layers 111, 112. This method is used, whereby the need to form vias in the substrate 101 is eliminated and manufacturing cost is reduced.

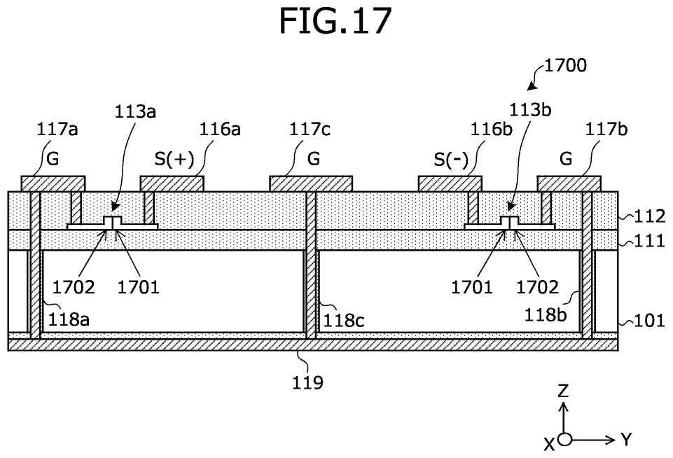

FIG. 17 is a cross-sectional view depicting an example of a configuration of a silicon optical modulator of a fifth example. While the present invention focuses on application to a modulator in which dissimilar materials are integrated on a silicon photonics substrate, the invention is further applicable to a conventional silicon modulator. Said conventional silicon optical modulator 500 corresponds to FIG. 5.

The optical modulating units 113 (113a, 113b) of the fifth example each has a p-type doped region 1701 and an n-type doped region 1702. The p-type doped region 1701 and the n-type doped region 1702 are connected, respectively, to the electrodes 116, 117. Further, the ground electrodes 117 (117a to 117c) are connected to the back electrode 119 of the substrate 101 through the vias 118 (118a, 118b, 118c), respectively.

As described in an eighth example hereinafter, while vias for another purpose may be formed, in this case, when formed concurrently with the vias 118, high-frequency electrical propagation mode conversion may be suppressed. Therefore, the need for dedicated measures such as the ground connection described in the prior art (FIGS. 7 to 9B) may be eliminated. Further, there is no need for the parts that are only ground connections and do not perform modulation as explained in FIG. 9 of the conventional technique, the length of the modulator may be shortened as compared to the conventional technology in FIG. 9, which has an advantage of enabling miniaturization.

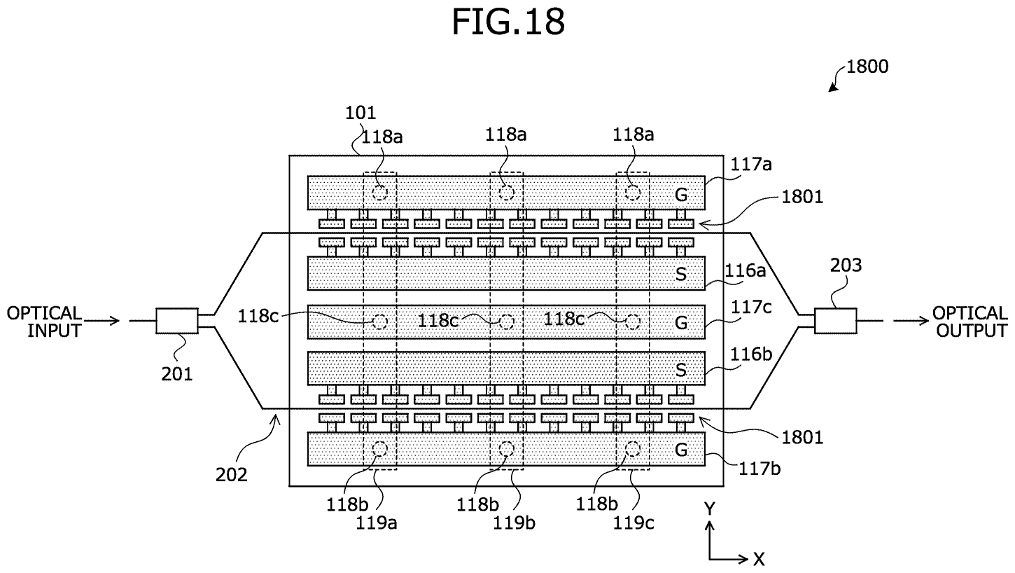

FIG. 18 is a top view depicting an example of configuration of an optical modulator having segmented electrodes 1801 of a sixth example. In FIG. 18, components identical to those depicted in FIGS. 2, 3A, and 3B are given the same reference numerals used in FIGS. 2, 3A, and 3B. As depicted in FIG. 18, when viewed from the upper surface, the electrodes of the GSGSG electrode configuration are disposed along the longitudinal direction X, the electrodes have a substantially “T” like shape, and are disposed facing one another with the optical waveguides intervening therebetween (for example, refer to Ran Ding, et.al, “High-Speed Silicon Modulator With Slow-Wave Electrodes and Fully Independent Differential Drive”). In addition to a segmented type, this electrode shape is also called a capacitance-loaded type, a slow wave type, a T-rail type, etc.

In the high-frequency electrode of the optical modulator, it is necessary to match the propagation speed of electricity with the propagation speed of light and since the propagation speed of the electrical signal may be reduced by using the structure depicted in FIG. 18, it is often used as an electrode structure for optical modulators. In the sixth example, the ground electrodes G (117), which are T-shaped electrodes, are connected to the back electrode 119 of the back surface of the substrate 101 through the vias 118. The structure of the sixth example eliminates the need to periodically dispose the connecting parts between the modulating portions and the grounds in the longitudinal direction X as in the conventional technology depicted in FIG. 9, and enables size reductions and reductions in the length of the modulator in the longitudinal direction X.

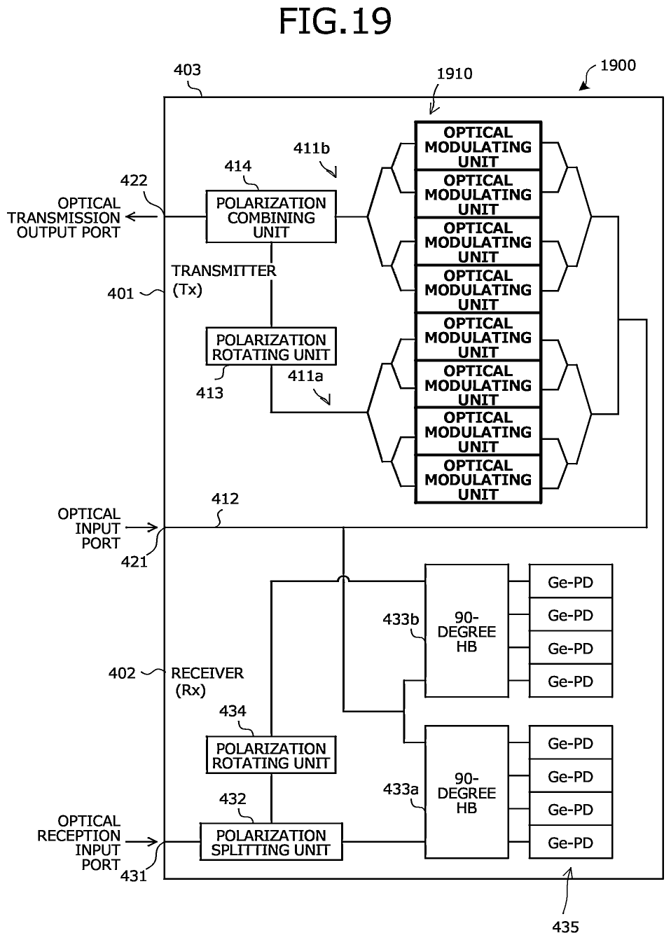

FIG. 19 is a top view depicting an example of a configuration of a transceiver of a seventh example. In FIG. 19, components identical to those in FIG. 4 are given the same reference numerals used in FIG. 4. A transceiver 1900 depicted in FIG. 19 is a transceiver in which the optical modulating unit 410 (corresponds to the optical modulator 100) with silicon photonics integration depicted in FIG. 4 is replaced with an optical modulating unit 1910 integrated with dissimilar materials (for example, high EO materials). While not depicted, similar to the examples describe above, the ground electrodes G (117) of the modulator 1910 are connected to each other at the back surface of the silicon substrate 403 or a portion lower than the modulator 1910 in the thickness direction.

According to the seventh example, high EO materials may be integrated on a silicon chip (the silicon substrate 403), from an upper side thereof. As a result, it is possible to manufacture integrated optical devices capable of high-speed modulation using modulators containing dissimilar materials while taking advantage of a feature of silicon photonics technology, which is an ability to compactly integrate optical components having needed functions.

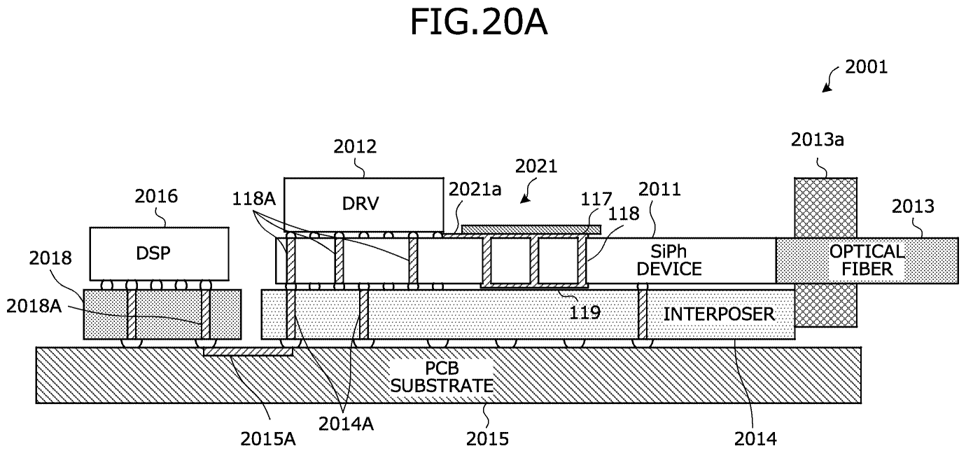

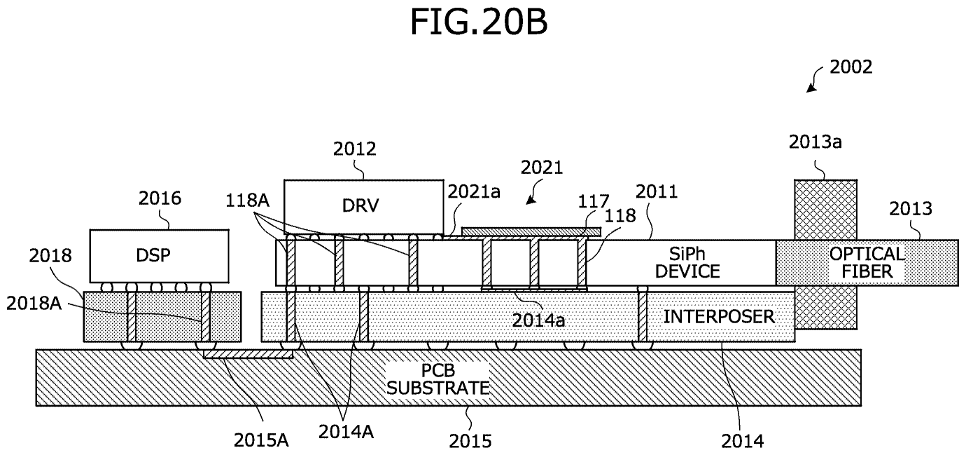

FIGS. 20A and 20B are cross-sectional views depicting an electro-optical converting device of an eighth example. An electro-optical converting device 2001 depicted in FIG. 20A includes, as a silicon chip in the seventh example, a silicon photonics device (SiPh device) 2011, a driver (DRV) 2012 for driving the SiPh device 2011, an optical fiber 2013 for inputting and outputting light, etc. Reference character 2013a is a fiber block for fixing the optical fiber 2013. These optical components are mounted on an interposer 2014.

As for the SiPh device 2011, for example, the ground electrodes G (117) in the optical modulating unit 2021 of high EO materials is in contact with the back electrode 119 through the vias 118. Between the optical modulating unit 2021 and the DRV 2012, the signal electrode(S) 116 and the ground electrodes G (117) are connected by wiring 2021a on the SiPh device 2011.

While the silicon photonics substrate, for example, is made thinner by polishing to have a thickness of about 100 microns to form the vias, the SiPh device 2011 is mounted on the interposer 2014, whereby the strength of the SiPh device 2011 may be reinforced and stress due to differences in the thermal expansion of the SiPh device 2011 and the thermal expansion of a PCB board 2015 which is lowermost may be mitigated. Further, spacing of back surface wiring of the SiPh device 2011 may be increased to facilitate mounting to the PCB board 2015.

Further, the electro-optical converting device 2001 is connected to a digital signal processor (DSP) 2016 through the PCB board 2015. In the SiPh device 2011, similarly as described above, the ground electrodes G (117) of the optical modulating unit 2021 are connected to each other by the back electrode 119, through the vias 118. In the eighth example, other vias 118A further provided in the SiPh device 2011 are used as a path to input to the DRV 2012, an electrical signal output from the DSP 2016.

From the DSP 2016 to the DRV 2012 is connected by vias 2018A of a DPS substrate 2018, wiring 2015A on the PCB board 2015, vias 2014A of the interposer 2014, the vias 118A of the SiPh device 2011.

In addition to the optical modulating unit 2021 (corresponds to the optical modulating units 113 in FIG. 1), the SiPh device 2011 may include the DRV 2012, while not depicted, a signal amplifying device for reception, or the DSP 2016, or a combination thereof.

Further, while an electro-optical converting device 2002 depicted in FIG. 20B is nearly the same as that in FIG. 20A, the connection of the ground electrodes G (117) differs. In the electro-optical converting device 2001 in FIG. 20A, connection to the ground is by the back electrode 119 in the second example (refer to FIG. 14C, etc.). In contrast, in the electro-optical converting device 2002 in FIG. 20B, connection is by the method depicted in FIG. 15A, in other words, through another substrate, for example, a ground pattern 2014a on the interposer 2014 without using the back electrode 119 of the SiPh device 2011.

In an instance in which the SiPh device 2011 is mounted on the interposer 2014, as is clear from FIG. 20B, this method is easy to apply. Either the method in FIG. 20A or the method in FIG. 20B may be selected as necessary.

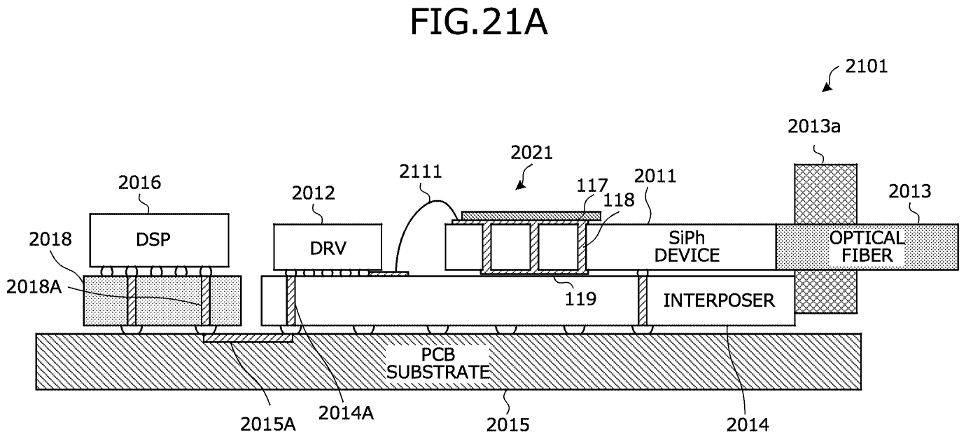

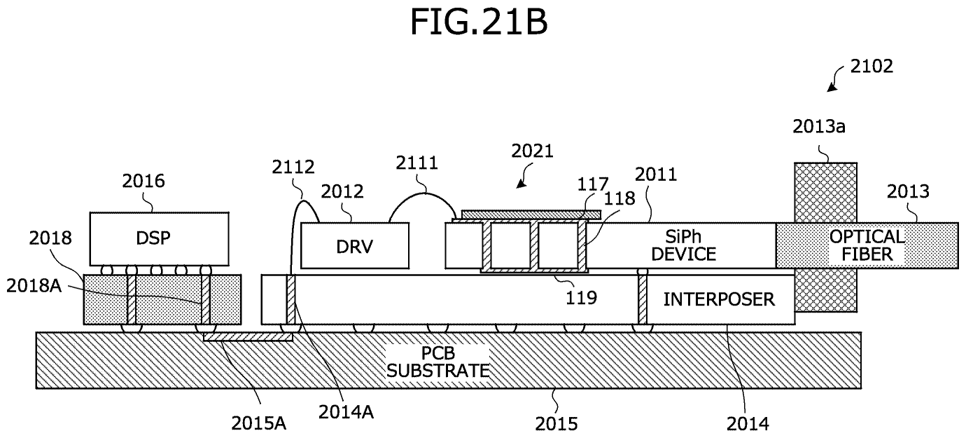

FIGS. 21A and 21B are cross-sectional views depicting an electro-optical converting device according to the conventional techniques, for comparison to the eighth example. For the sake of convenience, in FIGS. 21A and 21B, components identical to those in FIGS. 20A and 20B are given the same reference numerals used in in FIGS. 20A and 20B, and the DRV 2012 is disposed on the interposer 2014. An electro-optical converting device 2101 in FIG. 21A is an example in which the optical modulating unit 2021 and the DRV 2012 are connected to each other by a wire bonding 2111.

Further, an electro-optical converting device 2102 in FIG. 21B is an example of connecting the input and the output of the DRV 2012 by wire bonding. The DRV 2012 is connected to the optical modulating unit 2021 by the wire bonding 2111 and is connected to the DSP 2016 by a wire bonding 2112.

As described, the transmission speed of the electro-optical converting device 2001 has to support high-speed signal transmission of 64 Gbaud or 128 Gbaud, etc. The silicon photonics substrate (SiPh device) 2011 of the eighth example (FIGS. 20A and 20B), for example, reduced in thickness to about 100 microns by polishing; and a length (depth) of the vias 118A may be a distance shorter than the wire bonding 2111 depicted in FIG. 21A. Therefore, according to the eighth example, attenuation of high-frequency signals may be made smaller than that in an instance of wire bonding and thus, advantageous in high-speed transmission devices.

Further, in the eighth example, when the vias 118A are formed in the silicon photonics device 2011 for the purpose of high-speed transmission, the vias 118 for connecting the ground electrodes of the optical modulator, which is an application of the present invention, may be formed at the same time. This makes it possible to apply the present invention without any extra increase in cost.

The embodiments of the present invention including the examples above are described on the premise that the silicon substrate 101 and the vias 118 extending in the thickness direction of the substrate 101 are formed. High-frequency loss may be reduced the higher is the resistivity of the substrate 101 and thus, characteristics may be further improved by using a quartz substrate for the substrate 101. Formation of the vias 118 in the substrate 101 containing a glass such as quartz may be realized by through glass via (TGV) technology. Further, a passivation film may be provided on the electrodes (the signal electrodes 116, the ground electrodes 117) on the substrate 101 described in the examples.

As described, according to the optical modulator described in the embodiments, when an optical modulator function is introduced into a high-frequency electrode structure, high-frequency electrical propagation mode (slotline mode) conversion caused by resulting asymmetry in the structure is suppressed and degradation of characteristics of the optical modulator may be avoided. For example, the disclosure may be applied to optical modulators that integrate dissimilar materials, which is necessary for high-speed modulation of 64 Gbaud or higher. Further, application to silicon photonics integration devices as described in each example enables compact high-speed optical devices to be provided.

The present invention does not limit the materials used as modulator materials integrated on a substrate, and it is clear that the present invention may be applied to dielectric materials such as BTO and PLZT, and semiconductors such as InP, in addition to an EO polymer and LN that have been explained as examples. Further, the optical modulator with dissimilar material integration does not necessarily have to be formed on a silicon substrate, such as when forming a standalone optical modulator and, for example, a wafer may be used in which a SiO₂ film is formed on an LN substrate, and a thin film of LN is formed thereon. While LN is a material that is more difficult to process than silicon, provided the ground electrodes can be connected to the back surface or beneath the optical modulator, processing accuracy thereof is not an issue. Application of the present invention, for example, enables suppression of characteristics degradation caused by electrodes in a wide variety of optical modulators and enables broadening of the bandwidth of the optical modulator.

The optical device of the embodiments described above is provided in a substrate, at a first surface of the substrate; the optical device has an optical modulating unit that includes multiple electrodes that modulate optical signals, multiple vias that extend in a thickness direction of the substrate and that are connected to multiple ground electrodes that configure multiple electrodes, a second-surface electrode that is connected to the vias and that is provided at a second surface of the substrate, the second surface being opposite to the first surface. Thus, by a simple structure, slotline mode conversion may be suppressed and degradation of modular characteristics may be avoided.

Further, the optical device of the embodiments has optical waveguides in the substrate, at the first surface thereof and the optical modulating unit contains a material having an electro-optic constant higher than an electro-optic constant of the optical waveguides. Thus, a material having a high electro-optic constant (high EO coefficient) may be integrated in the optical modulating unit thereby enabling high-speed modulation operation.

Further, in the optical device of the embodiments, a material of the substrate may be silicon, silica, or quartz. The substrate containing these materials enables compact integration of an optical device such as a modulator on the substrate.

Further, in the optical device of the embodiments, the optical modulating unit may have a Mach-Zehnder type structure. Of the electrodes of this Mach-Zehnder optical modulating unit, the ground electrodes are connected to an electrode of the back surface through the vias, whereby slotline mode conversion may be suppressed by a simple structure.

Further, in the optical device of the embodiments, the optical modulating unit may have the GSGSG configuration (G: ground electrode, S: signal electrode) in which the electrodes correspond to a differential signal for driving. Further, the electrodes may be arranged in a GSG configuration, corresponding to a single output signal for driving. The vias are provided in the ground electrodes corresponding to these electrode configurations, whereby slotline mode conversion may be suppressed by a simple structure.

Further, the optical device of the embodiments may have a second substrate different from the substrate; the second substrate may have at a first surface thereof opposite to a second surface thereof, a ground electrode; and the vias and the ground electrode of the second substrate may be connected by bumps. In this instance, the substrate is moved in a direction to the second substrate, whereby the ground electrodes of the substrate may be connected to the ground electrode of the second substrate by the bumps, through the vias. Thus, for example, in the EO polymer optical modulator, the substrate is apart from the second substrate, whereby an EO polymer solution may be applied on the silicon waveguides, followed by a poling treatment for enabling function as an optical modulator, and thereafter, the substrate may be moved in a direction to the second substrate and connected to ground, simplifying manufacturing and inspection.

Further, in the optical device of the embodiments, a second-surface electrode may be provided in the substrate, between the first surface and the second surface. For example, the second-surface electrode is provided in the SiO₂ layer in the substrate, whereby the need to form vias in the substrate, beneath the silicon layer is eliminated thereby, enabling manufacturing at a lower cost.

Further, in the optical device of the embodiments, the electrodes may be segmented electrodes. In this instance as well, vias are formed in the ground electrodes of these electrode configurations, whereby slotline mode conversion may be suppressed by a simple structure.

Further, the transmitter of the embodiments may further have, on the substrate, the optical device above and an optical device having an optical transmission function. Furthermore, the transceiver of the embodiments may have on the substrate, the optical device above, a transmitter having an optical device with an optical transmission function, and an optical device with an optical receiving function. The transmitter having an optical device or a function of a transmitter and a receiver is mounted on the same substrate, whereby the cost and the size of the overall device may be reduced.

Further, in the optical device of the embodiments, the optical modulating unit above, a driving device of the optical modulating unit and/or a signal processing unit may be mounted on the substrate. Thus, in an instance in which functional units in addition to the optical modulating unit are implemented on the substrate, vias used for the functional units other than the optical modulating unit are formed in the substrate concurrently with the vias of the optical modulating unit, whereby the electro-optical converting device may be manufactured simply.

Further, in the optical device of the embodiments, the substrate may be reduced in thickness to a predetermined thickness and mounted on an interposer. Thus, the length (depth) of each of the vias may be shortened and the vias are used in the connections of the optical modulating unit and the functional units other than the optical modulating unit such as the driver, whereby, for example, attenuation of high-frequency signals may be reduced simply as compared to wire bonding.

The embodiments of the present invention achieve an effect in that the occurrence of the slotline mode may be suppressed by a simple structure.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical device, comprising:
a substrate having a first surface and a second surface opposite to each other;
an optical modulating unit provided in the substrate, at the first surface, the optical modulating unit having a plurality of electrodes for modulating an optical signal;
a plurality of vias extending in a thickness direction of the substrate and connected to a plurality of ground electrodes included in the plurality of electrodes; and
a second-surface electrode provided at the second surface of the substrate and connected to the plurality of vias.

2. The optical device according to claim 1, further comprising an optical waveguide provided in the substrate, at the first surface, wherein
the optical modulating unit has an electro-optic constant that is higher than an electro-optic constant of the optical waveguide.

3. The optical device according to claim 1, wherein a material of the substrate is silicon, silica, or quartz.

4. The optical device according to claim 1, wherein the optical modulating unit has a Mach-Zehnder type structure.

5. The optical device according to claim 1, wherein the optical modulating unit has a GSGSG configuration in which the plurality of electrodes corresponds to a differential signal for driving, in the GSGSG configuration, “G” indicating one of the plurality of ground electrodes and “S” indicating a signal electrode of the plurality of electrodes.

6. The optical device according to claim 1, wherein the optical modulating unit has a GSG configuration in which the plurality of electrodes corresponds to a single output signal for driving, in the GSG configuration, “G” indicating one of the plurality of ground electrodes and “S” indicating a signal electrode of the plurality of electrodes.

7. The optical device according to claim 1, further comprising a plurality of substrates, wherein
the substrate is a first substrate of the plurality of substrates,
the plurality of substrates includes a second substrate different from the first substrate, the second substrate having a first surface and a second surface opposite to each other, the first surface of the second substrate facing the second surface of the first substrate, a ground electrode being provided on the first surface of the second substrate, and
the ground electrode on the first surface of the second substrate and one of the plurality of vias are connected by a bump.

8. The optical device according to claim 1, wherein the second-surface electrode is disposed in the substrate, between the first surface and the second surface of the substrate.

9. The optical device according to claim 1, wherein the plurality electrodes includes a segmented electrode.

10. The optical device according to claim 1, wherein,
a thickness of the substrate is decreased to a predetermined thickness, and
the substrate is mounted on an interposer.

11. A transmitter, comprising:
a substrate having a first surface and a second surface opposite to each other;
an optical modulator provided on the substrate; and
an optical device related to an optical transmission function, wherein
the optical modulator has:
an optical modulating unit provided in the substrate, at the first surface, the optical modulating unit having a plurality electrodes for modulating an optical signal,
a plurality of vias extending in a thickness direction of the substrate and connected to a plurality of ground electrodes included in the plurality electrodes, and
a second-surface electrode provided at the second surface of the substrate and connected to the plurality of vias.

12. A transceiver, comprising:
a substrate having a first surface and a second surface opposite to each other;
an optical modulator provided on the substrate; and
an optical device related to an optical transceiver function, wherein
the optical modulator has:
an optical modulating unit provided in the substrate, at the first surface, the optical modulating unit having a plurality electrodes for modulating an optical signal,
a plurality of vias extending in a thickness direction of the substrate and connected to a plurality of ground electrodes included in the plurality electrodes, and
a second-surface electrode provided at the second surface of the substrate and connected to the plurality of vias.
